(19) United States
(12) Patent Application Publication
(10) Pub. No.: US 2024/0170703 A1
(43) Pub. Date: May 23, 2024

(54) COMPOSITE COMPOUND ADDITIVES INCLUDING A METAL OXIDE-CONTAINING SUB-COMPOUND AND A TUNGSTEN-CONTAINING SUB-COMPOUND FOR FUEL CELLS

(71) Applicant: GM GLOBAL TECHNOLOGY OPERATIONS LLC, Detroit, MI (US)

(72) Inventors: Ruichun Jiang, Troy, MI (US); Zhongyi Liu, Troy, MI (US); Nicholas P.W. Pieczonka, Windsor (CA)

(73) Assignee: GM GLOBAL TECHNOLOGY OPERATIONS LLC, Detroit, MI (US)

(21) Appl. No.: 17/988,891

(22) Filed: Nov. 17, 2022

(51) Int. Cl. H01M 8/1004

(52) U.S. Cl. CPC H01M 8/1004; H01M 2008/1095

(57) ABSTRACT

Membrane electrode assemblies for fuel cells and components thereof are provided. In one example, a membrane electrode assembly includes a generally planar gas-permeable body having opposed first and second faces defining in-plane directions and a through-plane direction, a side face extending about an outer perimeter of the body and adjoining each of the first and second faces, and an active region bounded in the through-plane direction by the first and second faces and in the in-plane directions by an active region perimeter defined generally within the outer perimeter. The active region includes a distribution of a composite compound additive dispersed across at least one of the in-plane and through-plane directions. The composite compound additive includes a metal oxide-containing sub-compound and a tungsten-containing sub-compound.

### INTRODUCTION

The present disclosure relates generally to fuel cells, and more particularly, relates to membrane electrode assemblies for fuel cells and components thereof including a composite compound additive dispersed therein that includes a metal oxide-containing sub-compound and a tungsten-containing sub-compound for enhancing durability of the fuel cell.

Fuel cells are electrochemical conversion devices that produce electrical energy by the oxidation and reduction, respectively, of hydrogen and oxygen. One of the factors that determines the commercial viability of a fuel cell is its durability. For example, a fuel cell for an automotive vehicle may be tasked to provide at least 5,000 hours of service. Further, commercial proton exchange membranes for heavy-duty fuel cell vehicles can require up to a five-fold increase in durability compared to that of light-duty fuel cell vehicles. Such high durability requirements may present a challenge to one or more of the fuel cell's membrane-electrode assembly (MEA) components, such as the polymer electrolyte membrane (PEM), the catalyst layers (CLs), the gas diffusion layers (GDLs), the micro-porous layers (MPLs) and any sub-gaskets or the like used in the MEA.

Various mechanical and chemical factors may contribute to the degradation of an MEA component(s) in a fuel cell. For example, production of oxidants including hydroxyl radicals (·OH) during operation of the fuel cell can contribute to chemical degradation in the MEA component(s). Strategies to improve the chemical durability of an MEA component include introducing precious metals such as platinum (Pt) or palladium (Pd), because of their strong catalytic activity for chemical reactions, into the PEM, and incorporating radical scavenger chemicals such as cerium (Ce) to scavenge the hydroxyl radicals. The radical scavenger chemicals can be introduced in the fuel cell system through ion exchange or additives of salt(s), such as, for example, Ce(NO₃)₃, Ce₂(CO₃)₃), or the like. For Ce-based radical scavengers, the Ce³⁺ state is the active state towards hydroxyl radical scavenging.

Within a perfluorosulfonic acid (PFSA) PEM membrane, cationic species, such as Ce³⁺ are complexed to the negatively charged sulfonate groups of the ionomer. However, cations from ion exchange or dissolvable cerium salt(s) may be susceptible to cation migration, accumulation and/or depletion. For example, in an operating fuel cell, factors such as a non-homogeneous water distribution in the plane of the PEM membrane can result in some areas across the PEM's active region that are comparatively “wet” (i.e., having a higher relative humidity (RH)) and other areas that are comparatively “dry” (i.e., having a lower RH). Complexed cations such as Ce³⁺ may migrate from relatively wet areas and concentrate in drier areas of the PEM/MEA. In extreme cases of disparate water distribution, Ce³⁺ can be severely depleted in certain wet regions, leading to early membrane degradation around these wet regions.

### SUMMARY

A membrane electrode assembly component is provided. The membrane electrode assembly includes a generally planar gas-permeable body having opposed first and second faces defining in-plane directions and a through-plane direction, a side face extending about an outer perimeter of the generally planar gas-permeable body and adjoining each of the opposed first and second faces, and an active region bounded in the through-plane direction by the opposed first and second faces and in the in-plane directions by an active region perimeter defined generally within the outer perimeter. The active region includes a distribution of a composite compound additive dispersed across at least one of the in-plane and through-plane directions. The composite compound additive includes a metal oxide (MOₓ)-containing sub-compound and a tungsten (W)-containing sub-compound.

In some embodiments, a chemical bond interaction is present between the MOₓ-containing sub-compound and the W-containing sub-compound.

In some embodiments, the composite compound additive is in a form of a plurality of solid bodies that are dispersed across the at least one of the in-plane and through-plane directions of the active region.

In some embodiments, the plurality of solid bodies are in a form selected from one of particles, flakes, nanofibers, fibers, and combinations thereof.

In some embodiments, the MOₓ-containing sub-compound is selected from one of a cerium (Ce) oxide-containing sub-compound, a manganese (Mn) oxide-containing sub-compound, a cerium zirconium (CeₓZr_{y}) oxide-containing sub-compound, and a cerium manganese (CeₓMn_{y}) oxide-containing sub-compound.

In some embodiments, the MOₓ-containing sub-compound is selected from one of CeO₂, MnO₂, CeₓZr_{y}O₄, CeₓMn_{y}O₄, and CeZrO₄.

In some embodiments, the W-containing sub-compound is selected from one of heteropoly acids of tungsten (HPA/W) and tungsten carbide (WC).

In some embodiments, the W-containing sub-compound is HPA/W includes H₈SiW₁₁O₃₉.

In some embodiments, the composite compound additive is selected from one of CeO₂—WC, MnO₂—WC, CeₓZr_{y}O₄—WC, CeₓMn_{y}O₄—WC, CeO₂-HIPA/W, CeZrO₄-IPA/W, MnO₂-HPA/W, and combinations thereof.

In some embodiments, the distribution is substantially uniform across the at least one of the in-plane and through-plane directions.

In some embodiments, the distribution varies across the at least one of the in-plane and through-plane directions.

In some embodiments, the distribution is disposed throughout a volume of the active region.

In some embodiments, the membrane electrode assembly component includes one of a polymer-electrolyte membrane, a gas diffusion layer, a micro-porous layer, a catalyst layer, a sub-gasket, and an adhesive.

In some embodiments, the composite compound additive is present in the one of the polymer-electrolyte membrane, the gas diffusion layer, the micro-porous layer, the catalyst layer, the sub-gasket, and the adhesive in an amount of from about 0.01% to about 20 wt. % based on a total weight of the corresponding one of the polymer-electrolyte membrane, the gas diffusion layer, the micro-porous layer, the catalyst layer, the sub-gasket, and the adhesive.

In some embodiments, a ratio of the MOₓ-containing sub-compound to the W-containing sub-compound is from about 0.1% to about 99.9%.

In some embodiments, the ratio of the MOₓ-containing sub-compound to the W-containing sub-compound is from about 25% to about 75%.

In some embodiments, the distribution is disposed at least one of (i) throughout a volume of the active region and (ii) as a coating on a surface of the active region.

According to an alternative embodiment, a membrane electrode assembly for a fuel cell is provided. The membrane electrode assembly includes a polymer-electrolyte membrane that is disposed between an anode and a cathode. At least one of the polymer-electrolyte membrane, the anode and the cathode has a generally planar gas-permeable body having opposed first and second faces defining in-plane directions and a through-plane direction, a side face extending about an outer perimeter of the generally planar gas-permeable body and adjoining each of the opposed first and second faces, and an active region bounded in the through-plane direction by the opposed first and second faces and in the in-plane directions by an active region perimeter defined generally within the outer perimeter. The active region includes a distribution of a composite compound additive dispersed across at least one of the in-plane and through-plane directions. The composite compound additive includes a MOₓ-containing sub-compound and a W-containing sub-compound.

In some embodiments, a chemical bond interaction is present between the MOₓ-containing sub-compound and the W-containing sub-compound.

According to an alternative embodiment, a membrane electrode assembly for a fuel cell is provided. The membrane electrode assembly includes a polymer-electrolyte membrane that is disposed between an anode and a cathode. At least one of the polymer-electrolyte membrane, the anode and the cathode has a generally planar gas-permeable body having opposed first and second faces defining in-plane directions and a through-plane direction, a side face extending about an outer perimeter of the generally planar gas-permeable body and adjoining each of the opposed first and second faces, and an active region bounded in the through-plane direction by the opposed first and second faces and in the in-plane directions by an active region perimeter defined generally within the outer perimeter. The active region includes a distribution of a composite compound additive dispersed across at least one of the in-plane and through-plane directions. The composite compound additive is selected from one of CeO₂—WC, MnO₂—WC, CeₓZr_{y}O₄—WC, CeₓMn_{y}O₄—WC, CeO₂-HIPA/W, CeZrO₄-HIPA/W, MnO₂-HIPA/W, and combinations thereof.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 is a schematic perspective view of a fuel cell according to an embodiment of the disclosure.

FIG. 2A is a schematic front view of an MEA component showing a distribution of a composite compound additive according to an embodiment of the disclosure.

FIG. 2B is a schematic side view of an MEA component showing a distribution of a composite compound additive according to an embodiment of the disclosure.

FIG. 2C is a close-up view of the dashed region of FIG. 2B showing a distribution of composite compound additive varying in a through-plane direction according to an embodiment of the disclosure.

FIG. 2D is a schematic perspective view of an MEA component according to an embodiment of the disclosure.

FIG. 3A is a schematic front view of an MEA component showing a distribution of a composite compound additive varying in a linear in-plane direction according to an embodiment of the disclosure.

FIG. 3B is a schematic front view of an MEA component showing a distribution of a composite compound additive varying in a radial in-plane direction according to an embodiment of the disclosure.

FIG. 4A-4D show transmission electron microscopy and energy-dispersive X-ray microscope (TEM-EDX) images of CeO₂—WC nano particle according to an embodiment of the disclosure.

FIG. 5 shows an X-ray photoelectron spectroscopy (XPS) Ce Oxidation State Analysis on CeO₂—WC nanoparticles compared to CeO₂ nanoparticles according to an embodiment of the disclosure.

FIG. 6 is a plot of open circuit voltage (OCV) vs. OCV time in hours test results for cases of no cerium added (A) compared to 4.6 mole % CeO₂—WC nanoparticles added (B) according to an embodiment of the disclosure.

FIG. 7 is a plot of fluoride release rate (FRR) vs. open circuit voltage (OCV) test results for cases of no cerium added (A) compared to 4.6 mole % CeO₂—WC nanoparticles added (B) according to an embodiment of the disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Unless specifically stated from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, the numerical values provided herein are modified by the term “about.”

The present disclosure relates to membrane electrode assemblies for fuel cells and components of membrane electrode assemblies. In accordance with one or more embodiments of the disclosure, a membrane electrode assembly component includes a generally planar gas-permeable body having opposed first and second faces defining in-plane directions and a through-plane direction. A side face extends about an outer perimeter of the body and adjoins each of the first and second faces. An active region is bounded in the through-plane direction by the first and second faces and in the in-plane directions by an active region perimeter defined generally within the outer perimeter. The active region includes a distribution of a composite compound additive dispersed across at least one of the in-plane and through-plane directions. The composite compound additive includes a metal oxide (MOₓ)-containing sub-compound and a tungsten (W)-containing sub-compound. As used herein, the term “sub-compound” is understood to mean a compound that forms part of a larger compound.

In some embodiments, both the MOₓ-containing sub-compound and the W-containing sub-compound independently have hydroxyl radical scavenging activity. As used herein, the phrase “hydroxyl radical scavenger” is understood to mean a substance, compound, or sub-compound that removes hydroxyl radicals (e.g., via a reaction to form a benign product(s)) to prevent damage that would otherwise result from the presence of hydroxyl radicals. As used herein, the phrase “hydroxyl radical scavenging activity” is understood to mean a substance, compound, or sub-compound that demonstrates an assessable ability to effectively remove hydroxyl radicals to prevent damage that would otherwise result from the presence of the hydroxyl radicals. In particular, the MOₓ-containing sub-compound independently has hydroxyl radical scavenging activity. Further, the W-containing sub-compound independently has hydroxyl radical scavenging activity, which may be less than, about the same as or greater than the hydroxyl radical scavenging activity of the MOₓ-containing sub-compound. As such, the combined hydroxyl radical scavenging activity of the composite compound additive is greater than the hydroxyl radical scavenging activity of either the MOₓ-containing sub-compound or the W-containing sub-compound individually for enhancing durability of the fuel cell.

In some embodiments, the MOₓ-containing sub-compound is a cerium (Ce) oxide-containing sub-compound. In some other embodiments, the MOₓ-containing sub-compound is a manganese (Mn) oxide-containing sub-compound. In some embodiments, the W-containing sub-compound is an heteropoly acid of tungsten (HPA/W). In some other embodiments, the W-containing sub-compound is tungsten carbide (WC). In an example of Ce oxide-containing sub-compound, the Ce-based radical scavengers go through regeneration from reversible redox cycling between the Ce³⁺ state and the Ce⁴⁺ state, as shown in Equations (1) and (2) as the example reaction pathways.

Ce³⁺+HO·→Ce⁴⁺+H₂O (1)

Ce⁴⁺+e→Ce³⁺ (2)

In Equation (1), Ce³⁺ reacts with the hydroxyl radical(s) (˜OH) to form Ce⁴⁺ and water (H₂O). The Ce⁴⁺ cation product has relatively low or no hydroxyl radical scavenging activity. However, regeneration from reversible redox cycling is illustrated in Equation (2), where Ce⁴⁺ regenerates back to Ce³⁺ and, again, is available for hydroxyl radical scavenging via Equation (1). As such, during operation of the fuel cell, the ratio of Ce³⁺/Ce⁴⁺ in the membrane electrode assembly component affects the durability of the fuel cell with a higher Ce³⁺/Ce⁴⁺ ratio providing enhanced durability relative to a lower Ce³⁺/Ce⁴⁺ ratio. The ratio of Ce³⁺/Ce⁴⁺ is dependent at least in part based on the respective chemical kinetics of Equation (1) and Equation (2), where higher reaction rates for Equation (2) favor higher Ce³⁺/Ce⁴⁺ ratios. In some embodiments, a chemical bond interaction is present between the MOₓ-containing sub-compound and the W-containing sub-compound. It has been surprisingly found that the chemical bond interaction between the MOₓ-containing sub-compound and the W-containing sub-compound provides a synergistic effect, for example increasing the ratio of Ce³⁺/Ce⁴⁺ by regeneration of Ce⁴⁺ to Ce³⁺ via Equation (2) to further enhance durability of the fuel cell. Additionally, because of the chemical bond interaction with the W-containing sub-compound, the ratio of Ce³⁺/Ce⁴⁺ increases on the surface of the CeOₓ-containing sub-compound (e.g., CeO₂), which provides an increase in potential reaction sites with hydroxyl radicals. Further, the W-containing sub-compound is a reductant and also helps to converts Ce⁴⁺ to Ce³⁺ during the reversible redox cycling reaction with hydroxyl radical scavenging.

In some embodiments, the composite compound additive is in a form of a plurality of solid bodies (e.g., particles, flakes, and/or fibers or nanofibers) that are dispersed across at least one of the in-plane and through-plane directions of the active region. Notably, the solid bodies of the composite compound additive remain as solid bodies that do not dissolve as otherwise occurs with additives of Ce-based salt(s). As such, the distribution of the solid bodies of the composite compound additive can be dispersed (e.g., uniformly or with different or varying concentrations) in the active region of the fuel cell and remain as distributed to reduce, minimize, or prevent localized accumulation and/or depleting of the active cations for hydroxyl radical scavenging, thereby further enhancing durability of the fuel cell.

Referring now to the drawings, wherein like numerals indicate like parts in the several views, an MEA component 48, and an MEA 12 and a fuel cell 10 including one or more of those MEA components 48, are shown and described herein.

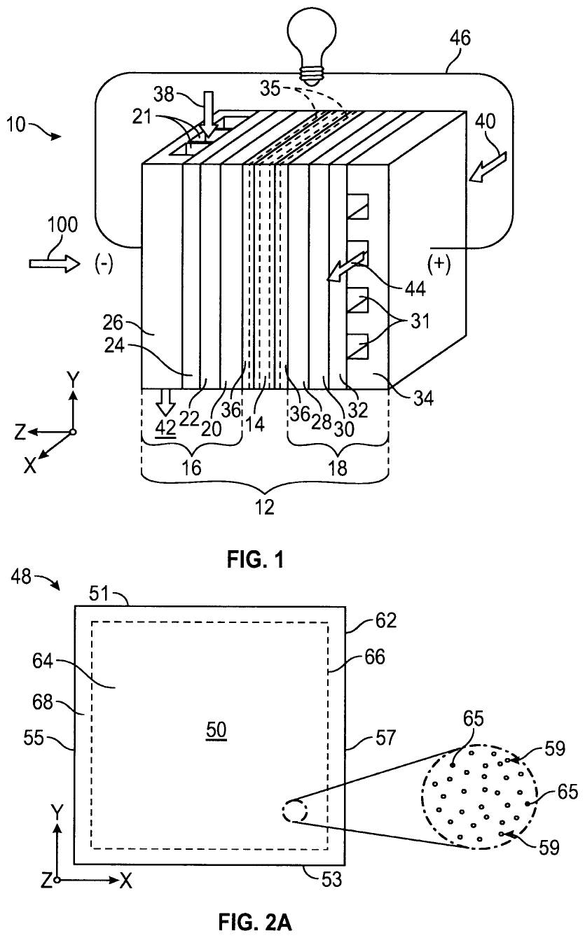

FIG. 1 shows a schematic representation of a fuel cell 10. As viewed in the drawing, the fuel cell 10 includes a PEM 14 sandwiched or otherwise disposed between an anode 16 and a cathode 18. Proceeding outward from the PEM 14, the anode 16 includes a catalyst layer 20, a micro-porous layer 22, a gas diffusion layer 24 and a bipolar plate 26. Similarly, proceeding outward from the PEM 14, the cathode 18 includes a catalyst layer 28, a micro-porous layer 30, a gas diffusion layer 32 and a bipolar plate 34. While sub-gaskets 36 are shown on either side of the PEM 14, these sub-gaskets 36 are optional and may be disposed between the other aforementioned layers. Alternatively, sub-gaskets 36 may be incorporated into the structure of these layers. Further, while adhesive 35 is shown in dashed lines of either side of the PEM 14 about the sub-gaskets 36, the adhesive 35 is optional and may be disposed between and/or about the other aforementioned layers, for example to provide additional sealing of the fuel cell 10. Collectively, the PEM 14, the CLs 20, 28, the MPLs 22, 30, the GDLs 24, 32 and the sub-gaskets 36 and/or adhesive 35 make up the MEA 12. Thus, the PEM 14, the CLs 20, 28, the MPLs 22, 30, the GDLs 24, 32, the sub-gaskets 36, and the adhesive 35 may be referred to herein as MEA components 48. Note, however, that while each of the anode 16 and cathode 18 is shown and described as having a respective CL 20, 28, a respective MPL 22, 30, and a respective GDL 24, 32, the functions of one or more of these components 48 may be combined with one or more other components 48, such that the respective functions of the CL, MPL and GDL do not have to be separated into individual components 48. Also, the terms “anode” 16 and “cathode” 18 may be used to refer to one or more of the three MEA electrode components described herein (i.e., the CL, the MPL and the GDL). For example, an “anode” 16 may include one or two of the anode CL 20, the anode MPL 22 and the anode GDL 24, and a “cathode” 18 may include one or two of the cathode CL 28, the cathode MPL 30 and the cathode GDL 32.

A fuel such as hydrogen gas 38 may enter flow channels 21 formed in the anode bipolar plate 26 (e.g., from the “top” of the fuel cell 10) and flow across the anode GDL 24. Some portion of this hydrogen gas 38 may flow through the GDL 24, while the remaining portion of the gas 42 exits the anode bipolar plate 26 (e.g., out the “bottom” of the fuel cell 10). Likewise, oxygen or air 40 may enter flow channels 31 formed in the cathode bipolar plate 34 (e.g., from the “back” of the fuel cell 10) and flow across the cathode GDL 32. Some portion of the oxygen or air 40 may flow through the GDL 32, while the remaining portion of the oxygen or air plus some water 44 exits the cathode bipolar plate 34 (e.g., out the “front” of the fuel cell 10). As the hydrogen gas 38 that enters the anode GDL 24 and other anode layers is oxidized, the hydrogen atoms' electrons are stripped off and flow in an electrical circuit 46 (e.g., that includes a load schematically illustrated as a light bulb) from the anode bipolar plate 26 to the cathode bipolar plate 34. Meanwhile, the remaining portions of the oxidized hydrogen atoms (i.e., their nuclei, which are protons) are transported across the fuel cell 10 from the anode 16 side to the cathode 18 side, where they combine with some of the incoming oxygen 40 and the anode-derived electrons which were introduced to the electrical circuit 46 to form water 44, which exits the fuel cell 10.

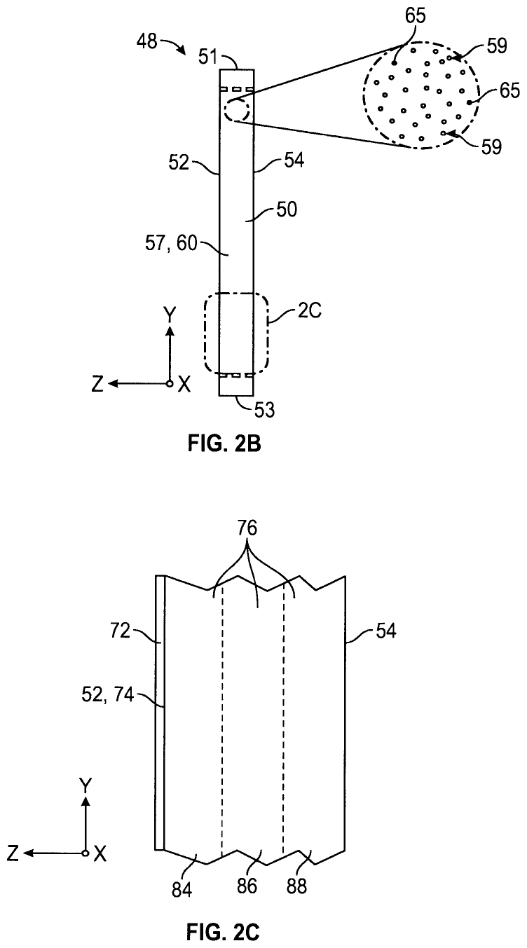

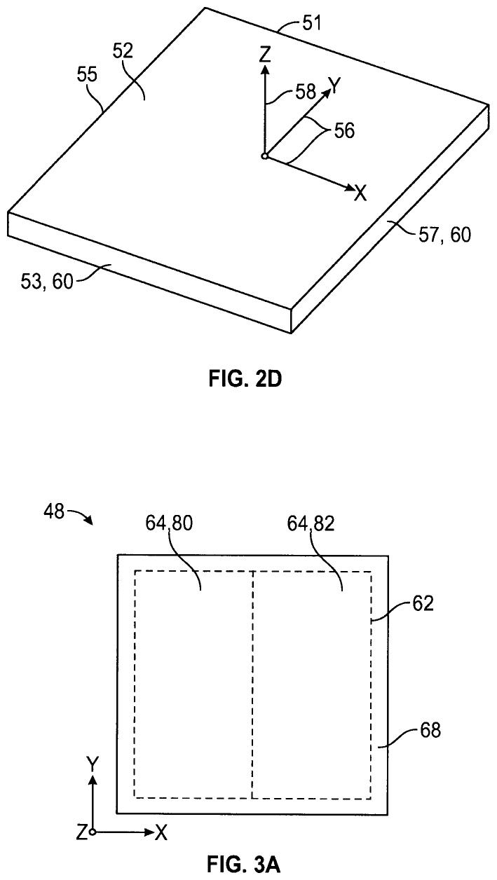

Note that the reference arrow 100 in FIG. 1 points from the left side of the drawing toward the anode bipolar plate 26. The arrow 100 points in the same direction as looking from the anode 16 or “(−)” side of the fuel cell 10 to the cathode 18 or “(+)” side of the fuel cell 10. This arrow 100 represents a view or perspective of the fuel cell 10 and its various components (including the MEA 12 and its individual MEA components 48) which is used in the present disclosure, along with the X-Y-Z axes shown in FIG. 2D as applied to an individual MEA component 48, to define certain directional descriptions. For example, the Y axis points “upward” in a positive direction toward a “top” side or edge 51 of the MEA component 48, the X axis points “rightward” in a positive direction toward a “right” side or edge 57 of the MEA component 48, and the Z axis points in a positive direction toward the anode 16 or “(−)” side of the fuel cell 10. Therefore, the negative direction of the Y axis points “downward” toward a “bottom” side or edge 53 of the MEA component 48, the negative direction of the X axis points “leftward” toward a “left” side or edge 55 of the MEA component 48, and the negative direction of the Z axis points toward the cathode 18 or “(+)” side of the fuel cell 10. Also note that the MEA component 48 has a generally planar body 50; that is, its X and Y dimensions (e.g., its length and width) are much larger than its Z dimension (e.g., its thickness). The generally planar body 50 has a first surface or face 52 facing in the anode 16 or “(−)” or positive Z direction, and a second surface or face 54 opposed from the first surface or face 52 and facing in the cathode 18 or “(−)” or negative Z direction. The generally planar shape of the body 50 and faces 52, 54 define in-plane or transverse directions 56 (e.g., X and Y directions, and other directions coplanar with the X-Y plane) and a through-plane direction 58 (e.g., a Z direction). Note that the foregoing directional conventions are presented merely for convenience and for facilitating the descriptions used in the present disclosure.

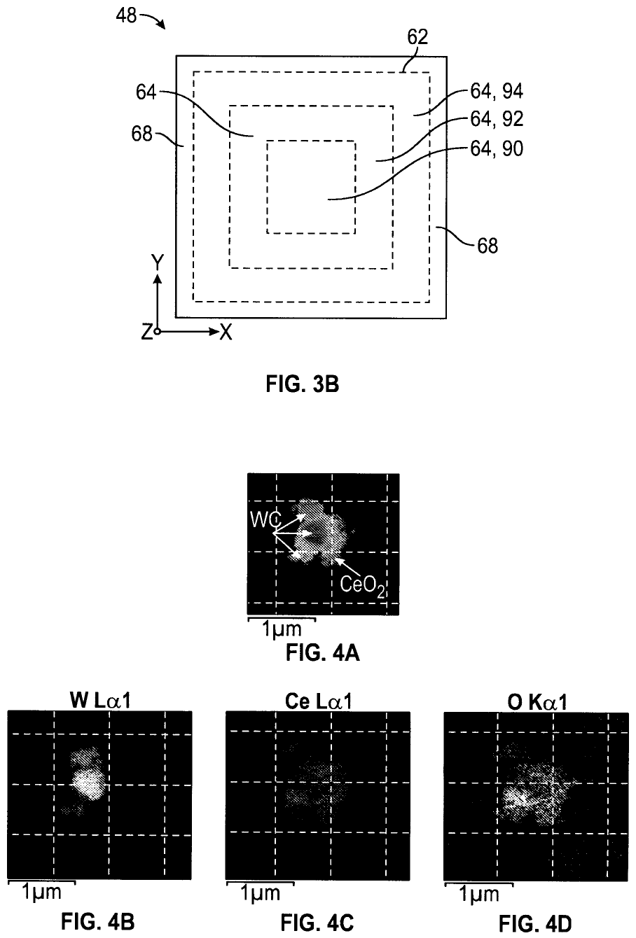

Referring now to FIGS. 2A-3B, various embodiments are shown of an MEA component 48 according to the present disclosure. As mentioned above, the PEM 14, the CLs 20, 28, the MPLs 22, 30, the GDLs 24, 32, the sub-gaskets 36, and the adhesive 35 may each be an MEA component 48. The MEA component 48 has a generally planar gas-permeable body 50 having opposed first and second faces 52, 54 defining in-plane directions 56 and a through-plane direction 58. A side face 60 extends about an outer perimeter 62 of the body and adjoins each of the first and second faces 52, 54. An active region 64 is bounded in the Z or through-plane direction 58 by the first and second faces 52, 54, and is bounded in the X and Y or in-plane directions 56 by an active region perimeter 66 which is defined generally within or inside of the outer perimeter 62. As illustrated in FIG. 2A, a rectangular MEA component 48 may have a rectangular active region 64 and a corresponding rectangular active region perimeter 66 (represented by the dashed rectangle) which may be spaced apart from the outer perimeter 62. As illustrated, the outer perimeter 62 is made up of the top edge 51, the bottom edge 53, the left edge 55, and the right edge 57. It should be noted that while the various segments of the active region perimeter 66 are illustrated in FIGS. 2A-3B as being evenly spaced apart from and within the outer perimeter 62, the various segments of the active region perimeter 66 may be spaced apart from the outer perimeter 62 by differing amounts. (In other words, some portions of the active region perimeter 66 may lie closer to the outer perimeter 62 than other portions. Also, at least some of the portions of the active region perimeter 66 may lie coincident with the outer perimeter 62.)

The active region 64 includes a distribution of a composite compound additive 59 dispersed across at least one of the in-plane and through-plane directions 56, 68. The composite compound additive 59 includes a metal oxide (MOₓ)-containing sub-compound and a tungsten (W)-containing sub-compound. In some embodiments, a ratio of the MOₓ-containing sub-compound to the W-containing sub-compound is from about 0.1% to about 99.9%, for example, from about 25% to about 75%.

In some embodiments, the MOₓ-containing sub-compound is a cerium (Ce) oxide-containing sub-compound, a manganese (Mn) oxide-containing sub-compound, a cerium zirconium (CeₓZr_{y}) oxide-containing sub-compound, or a cerium manganese (CeₓMn_{y}) oxide-containing sub-compound. In some embodiments, the MOₓ-containing sub-compound includes one of CeO₂, MnO₂, CeₓZr_{y}O₄, CeₓMn_{y}O₄, CeZrO₄, or a combination(s) thereof. For example, the molecular formula of the MOₓ-containing sub-compound may be CeZrO₄ (i.e., CeₓZr_{y}O₄ where x=1 and y=1), or other cerium-zirconium oxide(s) (e.g., 0≤x≤1, 0≤y≤1). Alternatively, the MOₓ-containing sub-compound may be a Ce oxide-containing sub-compound, a Mn oxide-containing sub-compound, or a CeₓMn_{y} oxide-containing sub-compound.

In some embodiments, the W-containing sub-compound is one of a heteropoly acid(s) of tungsten (HPA/W), tungsten carbide (WC), or a combination(s) thereof. For example, the W-containing sub-compound may be HPA/W, such as H₈SiW₁₁O₃₉ or other heteropoly acid of tungsten. Alternatively, the W-containing sub-compound may be WC or another W-containing sub-compound.

In one or more embodiments of the disclosure, a chemical bond interaction is present between the MOₓ-containing sub-compound and the W-containing sub-compound. Non-limiting examples of such composite compound additives 59 include one of CeO₂—WC, MnO₂—WC, CeₓZr_{y}O₄—WC, CeₓMn_{y}O₄—WC, CeO₂-HIPA/W, CeZrO₄-IPA/W, MnO₂-HIPA/W, or a combination(s) thereof.

In some embodiments, the composite compound additive 59 is in a form of a plurality of solid bodies 65 that are dispersed across at least one of the in-plane and through-plane directions 56, 68 of the active region 64. Non-limiting examples of the solid bodies 65 include particles (e.g., nanoparticles), flakes, nanofibers, fibers, or combinations thereof.

In some embodiments, the composite compound additive 59 is present in the active region 64 in an amount of from about 0.01% to about 20 wt. %. The distribution of the composite compound additive 59 may be substantially uniform across one or more of the in-plane and through-plane directions 56, 58, or it may vary across one or more of the in-plane and through-plane directions 56, 58. For example, the distribution of the composite compound additive 59 in the MEA component 48 shown in FIG. 2A may be uniform across both the X and Y in-plane directions of active region 64, or it may be uniform across one of those directions and non-uniform/varying across the other of those directions. In FIG. 3A, two areas 80, 82 of the active region 64 are shown; here, one of these areas 80, 82 may have a concentration of the composite compound additive 59 which is different (i.e., higher or lower) as compared to the concentration of the composite compound additive 59 in the other of the areas 80, 82. Likewise, in FIG. 3B, three concentric areas or zones 90, 92, 94 of the active region 64 are shown; here, the concentration of the composite compound additive 59 may vary radially from one area 90 to the other 92 and to the other 94. Note that while the distribution of the composite compound additive 59 discussed herein has focused on the active region 64 of the MEA component 48, the composite compound additive 59 may also be distributed within the inactive region 68 which lies between the active region perimeter 66 and the outer perimeter 62.

Referring now to FIGS. 2B-2C, in which a close-up side view of an MEA component 48 is shown, the distribution of the composite compound additive 59 may be disposed as a coating 72 on one or more surfaces 52, 54 of the active region 64 (such as the anode-facing surface 74). It may also be disposed throughout an interior volume 76 of the active region 64. In FIG. 2C, three parallel sections or thicknesses 84, 86, 88 are shown; here, the concentration of the composite compound additive 59 may vary among these sections 84, 86, 88. For example, it may be desired that the concentration of the composite compound additive 59 is higher toward the anode-facing side, so the concentration may be highest in section 84, lowest in section 88, and somewhere between highest and lowest in section 86.

Referring also to FIG. 1, according to one embodiment, an MEA 12 for a fuel cell 10 may include a PEM 14 sandwiched or otherwise disposed between an anode 16 and a cathode 18. At least one of the PEM, the anode 16 and the cathode 18 has a generally planar gas-permeable body 50 having opposed first and second faces 52, 54 defining in-plane (i.e., X and Y) transverse directions 56 and a through-plane (i.e., Z or thickness) direction 58. A side face 60 extends about an outer perimeter 62 of the body 50 and adjoins each of the first and second faces 52, 54. An active region 64 is bound in the through-plane direction 58 by the first and second faces 52, 54 and in the in-plane directions 56 by an active region perimeter 66 defined generally within the outer perimeter 62. The active region 64 includes a distribution of the composite compound additive 59 dispersed or distributed across at least one of the in-plane and through-plane directions 56, 58.

The following examples are provided for illustration purposes only and are not meant to limit the various embodiments of the MEA, its components, and/or the composite compound additive.

A. Synthesis of CeO₂—WC as an example composite compound additive is provided below.

Tungsten carbide (WC) was dispersed in water to a concentration of about 2 milligrams per milliliter (mg/mL). A Ce(NO₃)₃·6H₂O solution (concentration of about 30 millimoles (mM) in water) was added into the WC dispersion and sonicated for 1 hour. Next, a NaOH solution (concentration of about 0.1 moles (M)) was slowly added to the above mixture and stirred continuously until a PH of 9 to 10 was reached. The mixer solution was then sealed and heated for about 20 hours at about 180° C. Next, the solution was allowed to cool down to room temperature, and was centrifuged, washed with deionized water repetitively, and dried for all 12 hours at 80° C., followed by heat treating for about 6 hours at 200° C. The example CeO₂—WC was prepared with a 1:1 molar ratio of CeO₂ to WC.

FIGS. 4A-4D show the transmission electron microscopy and energy-dispersive X-ray microscope (TEM-EDX) images of CeO₂—WC nano particle materials synthesized and used as an example composite compound additive as discussed in further detail below.

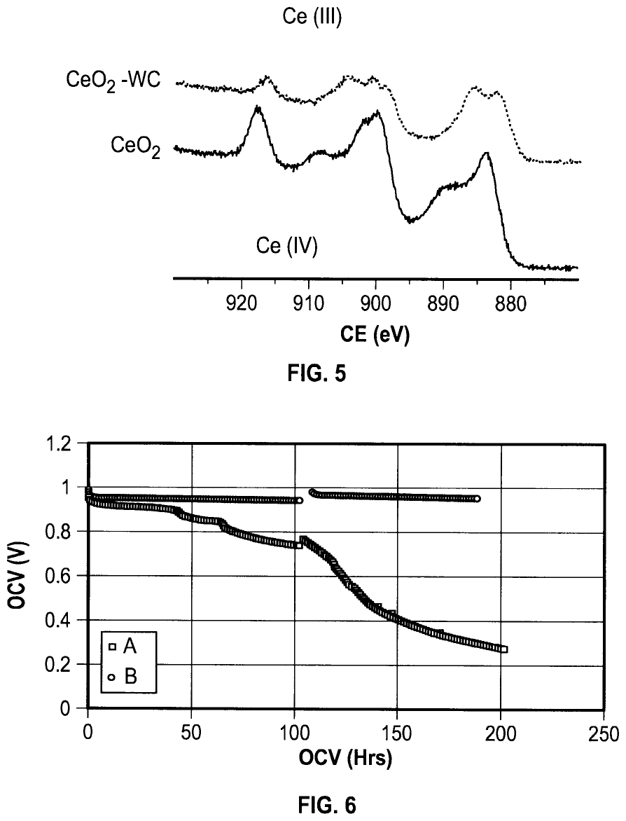

FIG. 5 shows the X-ray photoelectron spectroscopy (XPS) Ce Oxidation State Analysis on the CeO₂—WC nanoparticles synthesized as discussed above. The XPS spectra from CeO₂ showed the distinct multipeak spectrum of Ce (IV). The XPS spectra collected from the CeO₂—WC samples show a spectra with Ce (III) peaks with contributions from Ce₂O₃. Comparing to CeO₂, the CeO₂—WC shows increased ratio of Ce³⁺/Ce⁴⁺ on the surface of the particle. As previously discussed, a higher Ce³⁺/Ce⁴⁺ ratio enhances membrane chemical durability in fuel cells.

B. Application of the Composite Compound Additive in Fuel Cells is Provided Below.

The composite compound additive can be applied in various components or locations in fuel cells as described above in the disclosure.

As an example of the composite compound additives in fuel cell membranes, the membranes with the composite compound additive were coated with solutions containing ionomer and composite compound additive materials, while the reference non-additive membranes were coated with solutions containing ionomer materials. One example of developing the membranes with a composite compound additive includes the following procedure:

C. Preparation Coating Solution Containing the Composite Compound Additive and Ionomer is Provided Below.

An amount of composite compound additive (e.g., CeO₂—WC) and ionomer solution (e.g., Perfluorosulfonic Acid (PFSA)) are added into a solvent and stirred. Suitable solvents include water, alcohols and/or organic liquids. For example, a solution may be prepared having an additive-to-ionomer ratio in the range from 0.5:99.5 to 1:3 by weight, to get 0.5 to 25 wt. % of composite compound additive inside of the dry membranes/components (MEA component 48).

Diluted PFSA solutions without additives were also prepared with 5-20 wt. % concentration, for preparing the membranes without any additives.

D. Preparation of Membranes Containing the Composite Compound Additive is Provided Below.

An Erichsen coater with 10 inches by 15 inches of active membrane coating area may be used for membrane preparation. Dry membranes may be coated on a backer film (e.g., 50 μm polytetrafluoroethylene film). Multilayer membranes 48 may be prepared via a layer-by-layer procedure, using a series of single-step procedures with the coating height adjusted for each layer. A Bird applicator (Paul E. Gardner Co.) with selected slot thickness (in the range of 25-150 μm) may be used to coat each membrane layer with the additive/ionomer mixture. The thickness of each membrane layer may be controlled by the height of the Bird applicator slot which determines the amount of solution applied and the concentration of the coating solution.

For comparison purposes, membranes were also prepared without additives. The total thicknesses of the membranes were controlled around 20 microns (μm). The obtained membranes were then dried at about 80° C. for about 30 min., then heat treated at a temperature typically between 120 to 180° C. for about 20 min.

E. Preparation of MEA is Provided Below.

The membranes (single layer or multilayers) obtained through the above procedure were assembled into membrane electrode assembly (MEA). The MEA can optionally include a subgasket positioned between the PEM and the catalyst coated gas diffusion media (GDM) on one or both sides. The subgasket has the shape of a frame, and the size of the window is smaller than the size of the catalyst coated GDM and the size of the PEM. In this example, Pt/C is used to form the electrocatalyst layer and has a Pt loading of 0.15 mg/cm² at the cathode and 0.025 mg/cm² at the anode. The resulting MEA 12 can then be sandwiched between other components such as a pair of gas flow field/bipolar plates 26, 34 to form a single fuel cell 10.

F. Durability Testing of a Fuel Cell(s) is Provided Below.

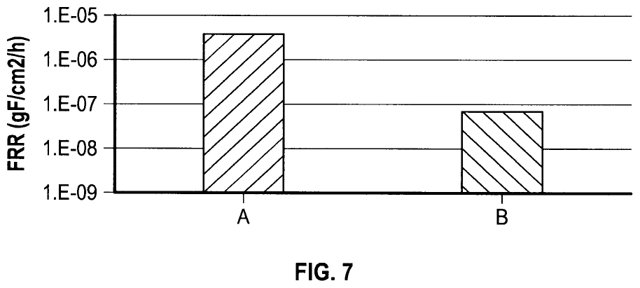

The MEAs assembled in fuel cell hardware were subjected to chemical durability tests under open circuit voltage (OCV) conditions. Some of the MEAs were configured as having membrane containing CeO₂—WC as an example composite compound additive; some of the MEAs were configured as having membrane containing no additive as a reference. Each of the MEAs were individually assembled in fuel cell hardware and tested for chemical durability under certain OCV conditions, including a standard test procedure at 110° C., and 25% RH for about 200 hours duration. Under these conditions, the MEAs were subject to chemical degradation due to the production of oxidants including hydroxyl radical (·OH) and H₂O₂. During this test, the fuel cells' OCVs were evaluated and recorded as an indication of fuel cell health. The emission water samples were collected during the OCV tests and analyzed for fluoride concentration, then the fluoride release rate (FRR) of fuel cell membranes were calculated. As fluoride is the degradation product of fuel cell membrane, the FRR result is an indication of extent of membrane chemical degradation in fuel cells. As shown, the OCV data in FIG. 6, the MEA containing additives (e.g., about 4.6% molar ratio of Ce to sulfonate groups (SO₃H) in fuel cell membrane) in the membrane demonstrated better durability with higher and stable OCV compared to the membrane without the additive. As shown in FIG. 7, the fuel cell containing CeO₂—WC in membrane has a lower averaged FRR throughout the test duration. These results indicate that the CeO₂—WC additive has a significant protection function of enhancing membrane chemical stability.

While the best modes for carrying out the disclosure have been described in detail, those familiar with the art to which this disclosure relates will recognize various alternative designs and embodiments for practicing the disclosure within the scope of the appended claims.

What is claimed is:

1. A membrane electrode assembly component, comprising:
a generally planar gas-permeable body having opposed first and second faces defining in-plane directions and a through-plane direction, a side face extending about an outer perimeter of the generally planar gas-permeable body and adjoining each of the opposed first and second faces, and an active region bounded in the through-plane direction by the opposed first and second faces and in the in-plane directions by an active region perimeter defined generally within the outer perimeter;
wherein the active region includes a distribution of a composite compound additive dispersed across at least one of the in-plane and through-plane directions, wherein the composite compound additive comprises a metal oxide (MOₓ)-containing sub-compound and a tungsten (W)-containing sub-compound.

2. The membrane electrode assembly component of claim 1, wherein a chemical bond interaction is present between the MOₓ-containing sub-compound and the W-containing sub-compound.

3. The membrane electrode assembly component of claim 1, wherein the composite compound additive is in a form of a plurality of solid bodies that are dispersed across the at least one of the in-plane and through-plane directions of the active region.

4. The membrane electrode assembly component of claim 3, wherein the plurality of solid bodies are in a form selected from one of particles, flakes, nanofibers, fibers, and combinations thereof.

5. The membrane electrode assembly component of claim 1, wherein the MOₓ-containing sub-compound is selected from one of a cerium (Ce) oxide-containing sub-compound, a manganese (Mn) oxide-containing sub-compound, a cerium zirconium (CeₓZr_{y}) oxide-containing sub-compound, and a cerium manganese (CeₓMn_{y}) oxide-containing sub-compound.

6. The membrane electrode assembly component of claim 5, wherein the MOₓ-containing sub-compound is selected from one of CeO₂, MnO₂, CeₓZr_{y}O₄, CeₓMn_{y}O₄, and CeZrO₄.

7. The membrane electrode assembly component of claim 1, wherein the W-containing sub-compound is selected from one of heteropoly acids of tungsten (HPA/W) and tungsten carbide (WC).

8. The membrane electrode assembly component of claim 7, wherein the W-containing sub-compound is HPA/W comprising H₈SiW₁₁O₃₉.

9. The membrane electrode assembly component of claim 1, wherein the composite compound additive is selected from one of CeO₂—WC, MnO₂—WC, CeₓZr_{y}O₄—WC, CeₓMn_{y}O₄—WC, CeO₂—HPA/W, CeZrO₄—IPA/W, MnO₂—IPA/W, and combinations thereof.

10. The membrane electrode assembly component of claim 1, wherein the distribution is substantially uniform across the at least one of the in-plane and through-plane directions.

11. The membrane electrode assembly component of claim 1, wherein the distribution varies across the at least one of the in-plane and through-plane directions.

12. The membrane electrode assembly component of claim 1, wherein the distribution is disposed throughout a volume of the active region.

13. The membrane electrode assembly component of claim 1, wherein the membrane electrode assembly component comprises one of a polymer-electrolyte membrane, a gas diffusion layer, a micro-porous layer, a catalyst layer, a sub-gasket, and an adhesive.

14. The membrane electrode assembly component of claim 13, wherein the composite compound additive is present in the one of the polymer-electrolyte membrane, the gas diffusion layer, the micro-porous layer, the catalyst layer, the sub-gasket, and the adhesive in an amount of from about 0.01% to about 20 wt. % based on a total weight of the corresponding one of the polymer-electrolyte membrane, the gas diffusion layer, the micro-porous layer, the catalyst layer, the sub-gasket, and the adhesive.

15. The membrane electrode assembly component of claim 1, wherein a ratio of the MOₓ-containing sub-compound to the W-containing sub-compound is from about 0.1% to about 99.9%.

16. The membrane electrode assembly component of claim 15, wherein the ratio of the MOₓ-containing sub-compound to the W-containing sub-compound is from about 25% to about 75%.

17. The membrane electrode assembly component of claim 1, wherein the distribution is disposed at least one of (i) throughout a volume of the active region and (ii) as a coating on a surface of the active region.

18. A membrane electrode assembly for a fuel cell, comprising:
a polymer-electrolyte membrane disposed between an anode and a cathode;
wherein at least one of the polymer-electrolyte membrane, the anode and the cathode has a generally planar gas-permeable body having opposed first and second faces defining in-plane directions and a through-plane direction, a side face extending about an outer perimeter of the generally planar gas-permeable body and adjoining each of the opposed first and second faces, and an active region bounded in the through-plane direction by the opposed first and second faces and in the in-plane directions by an active region perimeter defined generally within the outer perimeter;
wherein the active region includes a distribution of a composite compound additive dispersed across at least one of the in-plane and through-plane directions, wherein the composite compound additive comprises a MOₓ-containing sub-compound and a W-containing sub-compound.

19. The membrane electrode assembly of claim 18, wherein a chemical bond interaction is present between the MOₓ-containing sub-compound and the W-containing sub-compound.

20. A membrane electrode assembly for a fuel cell, comprising:
a polymer-electrolyte membrane disposed between an anode and a cathode;
wherein at least one of the polymer-electrolyte membrane, the anode and the cathode has a generally planar gas-permeable body having opposed first and second faces defining in-plane directions and a through-plane direction, a side face extending about an outer perimeter of the generally planar gas-permeable body and adjoining each of the opposed first and second faces, and an active region bounded in the through-plane direction by the opposed first and second faces and in the in-plane directions by an active region perimeter defined generally within the outer perimeter;
wherein the active region includes a distribution of a composite compound additive dispersed across at least one of the in-plane and through-plane directions, wherein the composite compound additive is selected from one of CeO₂—WC, MnO₂—WC, CeₓZr_{y}O₄—WC, CeₓMn_{y}O₄—WC, CeO₂—HIPA/W, CeZrO₄—HIPA/W, MnO₂—HIPA/W, and combinations thereof.
